(19) United States
(12) Patent Application Publication
(10) Pub. No.: US 2024/0199386 A1
(43) Pub. Date: Jun. 20, 2024

(54) HOIST FOR MOUNTING TO A TRAILER BED

(71) Applicant: Shaun Ray, Wolfforth, TX (US)

(72) Inventor: Shaun Ray, Wolfforth, TX (US)

(21) Appl. No.: 18/082,161

(22) Filed: Dec. 15, 2022

(51) Int. Cl. B66C 23/44

(52) U.S. Cl. CPC B66C 23/44

(57) ABSTRACT

A hoisting system for lifting objects to load them onto and unload them from a trailer bed includes a trailer bed having a stake pocket extending into an upper surface of the trailer bed. A post is removably extendable into the stake pocket such that the post is removably attached to and extends upwardly from the trailer bed. A boom is coupled to the post. A spool is rotatably mounted to the post, and a cable is wound on the spool. A drive assembly is mechanically coupled to the spool and is actuatable to rotate the spool.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hoists and more particularly pertains to a new hoist for lifting objects to load them onto and unload them from a trailer bed.

### (2) Description of Related Art Including Information Disclosed Under 37 CFR 1.97 and 1.98

The prior art relates to hoists including hoists that are mounted to a bumper or truck bed of a pickup truck.

### BRIEF SUMMARY OF THE INVENTION

An embodiment of the disclosure meets the needs presented above by generally comprising a trailer bed having a stake pocket extending into an upper surface of the trailer bed. A post is removably extendable into the stake pocket such that the post is removably attached to and extends upwardly from the trailer bed. A boom is coupled to the post adjacent to a top end of the post. A spool is rotatably mounted to the post, and a cable is wound on the spool. The cable is wound onto the spool when the spool is rotated in a first direction and unwound from the spool when the spool is rotated in a second direction. The cable has a free end extending away from the spool with is attachable to an object to be lifted onto the trailer bed. A drive assembly is mechanically coupled to the spool and is actuatable to rotate the spool in the first direction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of elements of a hoisting system according to an embodiment of the disclosure.

FIG. 2 is a side view of elements of an embodiment of the disclosure.

FIG. 3 is a front view of elements of an embodiment of the disclosure.

FIG. 4 is a side view of elements of an embodiment of the disclosure.

FIG. 5 is a perspective in-use view of an embodiment of the disclosure.

FIG. 6 is a cross-sectional view of an embodiment of the disclosure from Arrows 6-6 in FIG. 2.

FIG. 7 is a cross-sectional view of an embodiment of the disclosure from Arrows 7-7 in FIG. 3.

### DETAILED DESCRIPTION OF THE INVENTION

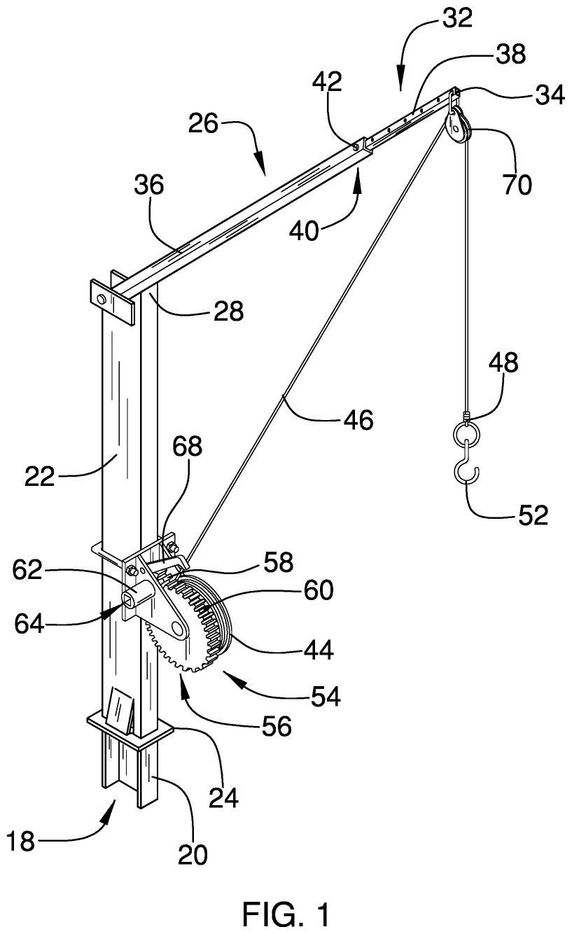

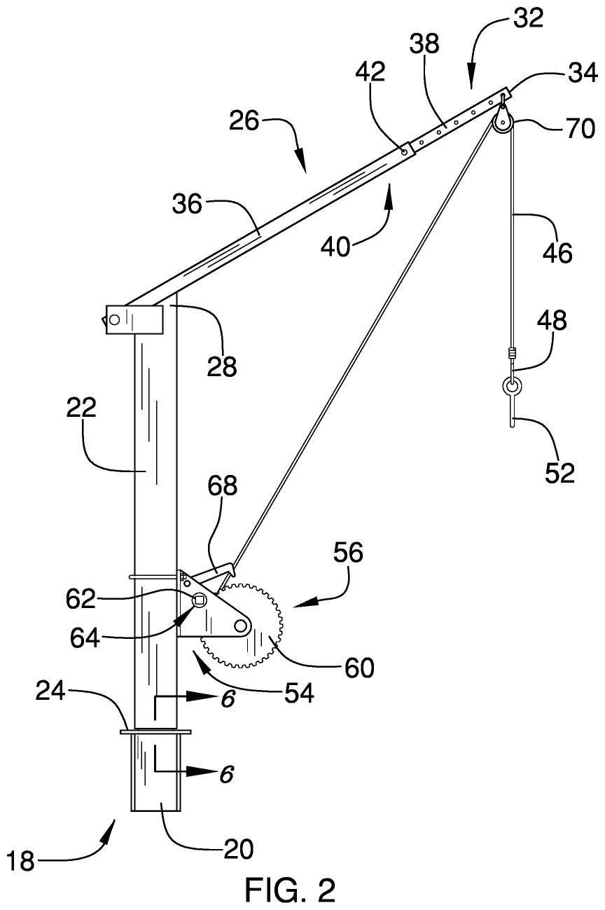

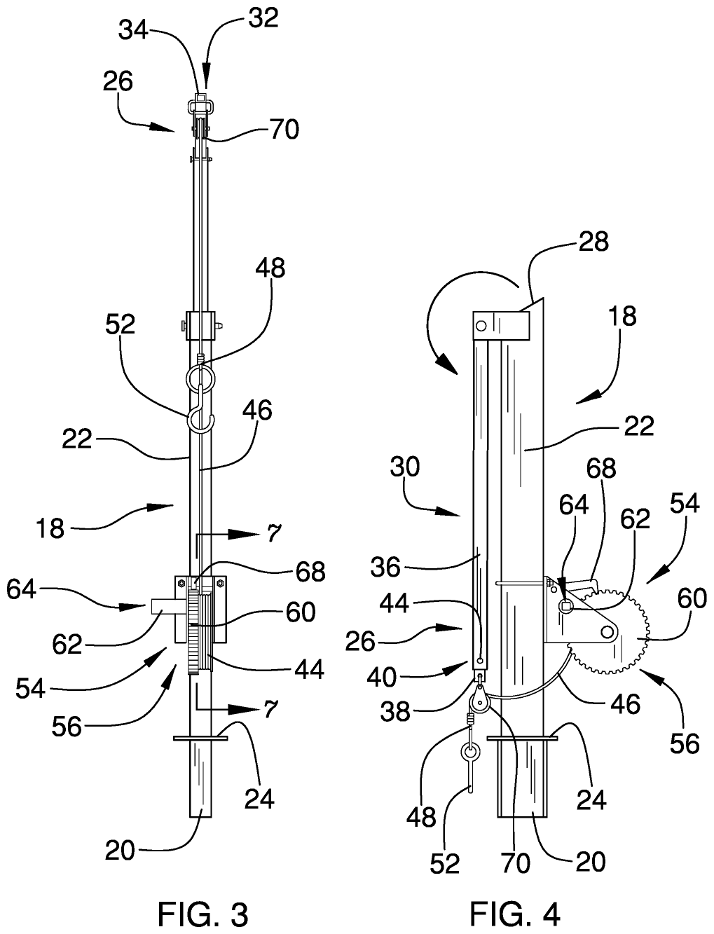

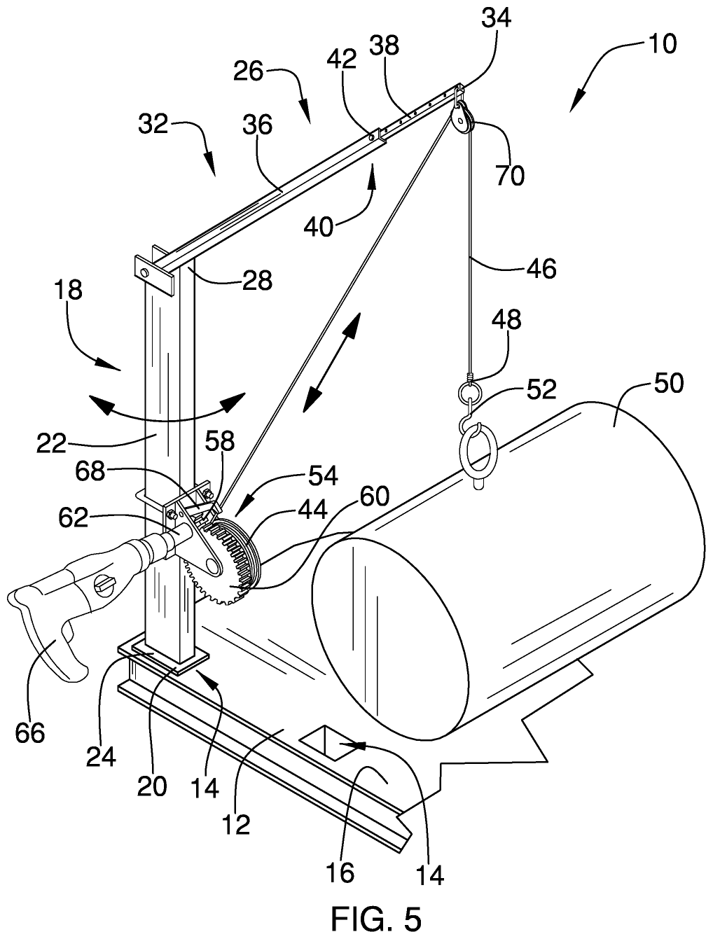

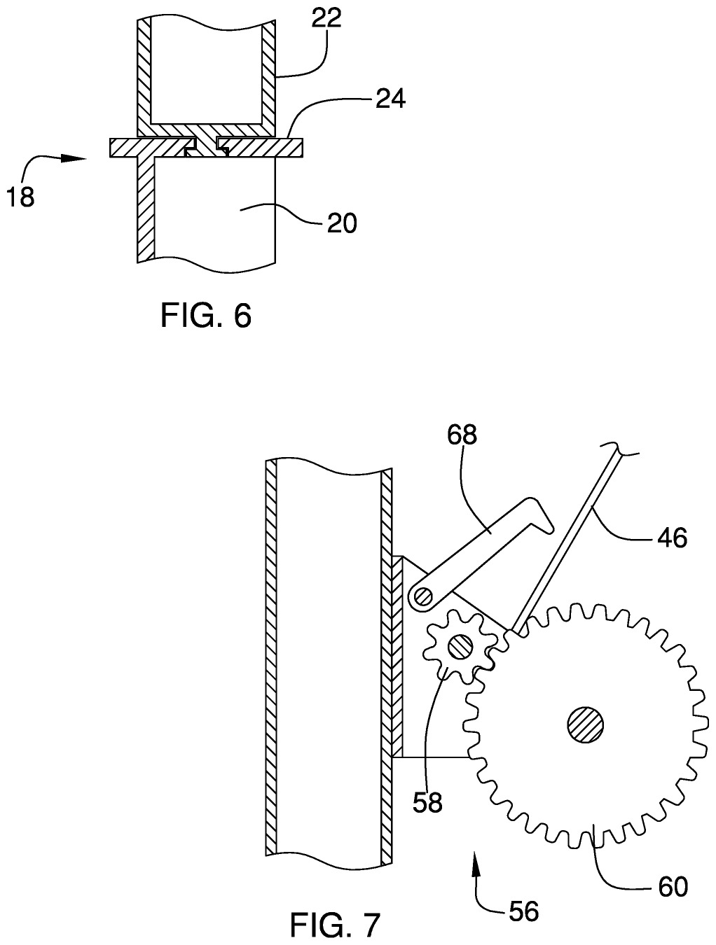

With reference now to the drawings, and in particular to FIGS. 1 through 7 thereof, a new hoist embodying the principles and concepts of an embodiment of the disclosure and generally designated by the reference numeral 10 will be described.

As best illustrated in FIGS. 1 through 7, the hoisting system 10 generally comprises a trailer bed 12 having a stake pocket 14 which extends into an upper surface 16 of the trailer bed 12. A post 18 is removably extendable into the stake pocket 14 such that the post 18 is removably attached to and extends upwardly from the trailer bed 12. The post 18 comprises an insertion member 20 and a column 22. The insertion member 20 is shaped to be insertable into the stake pocket 14 of the trailer bed 12 such that the post 18 is removably attached to the trailer bed 12. A column 22 is coupled to a top side 24 of the insertion member 20 and extends upwardly from the insertion member 20. The column 22 is rotatable relative to the insertion member 20 about a vertical axis extending through the column 22 and the insertion member 18.

A boom 26 is coupled to the post 18 adjacent to a top end 28 of the post 18. The boom 26 is pivotally coupled to the post 18 such that the boom 26 is movable between a stored condition 30 folded against the post 18 and a deployed condition 32 extending laterally away from the post 18. The boom 26 engages and is supported by the top end 28 of the post 18 when the boom 26 is in the deployed condition 32 to retain the boom 26 in the deployed condition 32. The boom 26 angles upwardly from the post 18 to a distal end 34 of the boom 26 relative to the post 18 when positioned in the deployed condition 32. The boom 26 is also telescopic and has an adjustable length. The boom 26 comprises a first section 36 adjacent to the post 18 and a second section 38 which is slidably coupled to and extendable outwardly away from the first section 36 to a selected length. A lock 40 releasably secures the second section 38 to the first section 36 at the selected length. The lock 40 may include a pin 42 for securing the second member to the first member in a selected one of a plurality of positions. The lock 40 may include a latch, catch, or the like.

A spool 44 is rotatably mounted to the column 22, and a cable 46 is wound on the spool 44. The cable 46 has a free end 48 extending away from the spool 44. The cable 46 is wound onto the spool 44 when the spool 44 is rotated in a first direction and unwound from the spool 44 when the spool 44 is rotated in a second direction. The free end 48 is attachable to an object 50 to be lifted onto the trailer bed 12 and may include a hook 52. Nets, baskets, straps, or the like may also or alternatively be attached to the free end 48 for attaching to the object 50. A drive assembly 54 is mechanically coupled to the spool 44 and is actuatable to rotate the spool 44 in the first direction. The drive assembly 54 may include a gear train 56 including a pinion 58 operatively coupled to an output gear 60 which is fixedly coupled to the spool 44 such that rotation of the pinion 58 results in rotation of the spool 44 in one of the first and second directions. An input 62 may be fixedly coupled to the pinion 58 which includes a socket 64 shaped and positioned such that a drill 66 can engage the input to rotate the pinion 58. The drive assembly 54 may also include a catch 68 which is movable to engage the gear train 56 to prevent rotation of the spool 44. The drive assembly 54 may also include a hand crank, electric motor, hydraulic motor, pneumatic motor, or the like to rotate the spool 44.

The cable 46 movably engages the boom 26 distal to the post 18. A pulley 70 may be mounted on the boom 26 distal to the post 18, and the cable 46 may be positioned on the pulley 70.

In use, the insertion member 20 of the post 18 is inserted into the stake pocket 14 to mount the post 18 to the trailer bed 12 while the boom 26 is in the stored condition 30. The boom 26 is then pivotably moved relative to the post 18 to position the boom 26 in the deployed condition 32. The free end 48 of the cable 46 is attached to the object 50, and the drive assembly 54 is actuated to wind the cable 46 and lift the object 50. The column 22 is pivoted around the vertical axis so that the object 50 is positioned above the trailer bed 12. Then the drive assembly 54 is actuated to unwind the cable 46 and lower the object 50 onto the trailer bed 12. The hoisting system 10 can also be operated to lift an object 50 off the trailer bed 12 and lower it onto another surface. The boom 26 is pivoted into the stored condition 30 and the insertion member 20 is removed from the stake pocket 14 for storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hoist system comprising:
a trailer bed having a stake pocket extending into an upper surface of the trailer bed;
a post being removably extendable into the stake pocket such that the post is removably attached to and extends upwardly from the trailer bed;
a boom being coupled to the post adjacent to a top end of the post;
a spool being rotatably mounted to the post;
a cable being wound on the spool, the cable having a free end extending away from the spool, the cable being wound onto the spool when the spool is rotated in a first direction and unwound from the spool when the spool is rotated in a second direction, wherein the free end is attachable to an object to be lifted onto the trailer bed; and
a drive assembly being mechanically coupled to the spool, the drive assembly being actuatable to rotate the spool in the first direction.

2. The system of claim 1, wherein the post comprises:
an insertion member being shaped to be insertable into the stake pocket of the trailer bed such that the post is removably attached to the trailer bed and extends upwardly therefrom; and
a column being coupled to a top side of the insertion member and extending upwardly therefrom, the column being rotatable relative to the insertion member about a vertical axis extending through the column and the insertion member.

3. The system of claim 2, wherein the spool is positioned on the column.

4. The system of claim 1, wherein the boom is pivotally coupled to the post such that the boom is movable between a stored condition folded against the post and a deployed condition extending laterally away from the post, the boom engaging and being supported by the top end of the post when the boom is in the deployed condition to retain the boom in the deployed condition, the deployed condition of the boom including the boom being angled upwardly from the post to a distal end of the boom relative to the post.

5. The system of claim 1, wherein the boom is telescopic and having an adjustable length.

6. The system of claim 5, wherein the boom comprises:
a first section adjacent to the post and a second section being slidably coupled to and extendable outwardly away from the first section to a selected length; and
a lock releasably securing the second section to the first section at the selected length.

7. The system of claim 6, wherein the lock includes a pin for securing the second member to the first member in a selected one of a plurality of positions.

8. The system of claim 1, wherein the cable movably engages the boom distal to the post.

9. The system of claim 8, further comprising a pulley being mounted on the boom distal to the post, the cable being positioned on the pulley.

10. The system of claim 1, further comprising a hook being attached to the free end of the cable.

11. A hoist system comprising:
a trailer bed having a stake pocket extending into an upper surface of the trailer bed;
a post being removably extendable into the stake pocket such that the post is removably attached to and extends upwardly from the trailer bed, the post comprising:
an insertion member being shaped to be insertable into the stake pocket of the trailer bed such that the post is removably attached to the trailer bed and extends upwardly therefrom; and
a column being coupled to a top side of the insertion member and extending upwardly therefrom, the column being rotatable relative to the insertion member about a vertical axis extending through the column and the insertion member;
a boom being coupled to the post adjacent to a top end of the post, the boom being pivotally coupled to the post such that the boom is movable between a stored condition folded against the post and a deployed condition extending laterally away from the post, the boom engaging and being supported by the top end of the post when the boom is in the deployed condition to retain the boom in the deployed condition, the deployed condition of the boom including the boom being angled upwardly from the post to a distal end of the boom relative to the post, the boom being telescopic and having an adjustable length, the boom comprising:
a first section adjacent to the post and a second section being slidably coupled to and extendable outwardly away from the first section to a selected length; and
a lock releasably securing the second section to the first section at the selected length, the lock including a pin for securing the second member to the first member in a selected one of a plurality of positions;
a spool being rotatably mounted to the post;
a cable being wound on the spool, the cable having a free end extending away from the spool, the cable being wound onto the spool when the spool is rotated in a first direction and unwound from the spool when the spool is rotated in a second direction, wherein the free end is attachable to an object to be lifted onto the trailer bed;
a drive assembly being mechanically coupled to the spool, the drive assembly being actuatable to rotate the spool in the first direction;
the spool being positioned on the column;
the cable movably engaging the boom distal to the post;
a pulley being mounted on the boom distal to the post, the cable being positioned on the pulley; and
a hook being attached to the free end of the cable.
